(19) United States
(12) Patent Application Publication
(10) Pub. No.: US 2016/0102909 A1
(43) Pub. Date: Apr. 14, 2016

(54) A METHOD OF EVAPORATING LIQUID AND DRYING STATIC BED OF PARTICLES WITHIN A CONTAINER AND RECOVERING WATER CONDENSATE

(71) Applicant: Narashimhamurthy PRAKASHKUMAR, London (GB)

(72) Inventor: Prakashkumar Narasimhamurthy, London (GB)

(21) Appl. No.: 14/893,064

(22) PCT Filed: Jun. 3, 2014
(86) PCT No.: PCT/GB2014/000216

§ 371 Date: Nov. 22, 2015

(30) Foreign Application Priority Data
Jun. 3, 2013 (GB) 1309845.4

(51) Int. Cl. F26B 3/06; F26B 9/06; F26B 25/00

(52) U.S. Cl. CPC F26B 3/06; F26B 25/006; F26B 9/063

(57) ABSTRACT

A method of evaporating liquid and drying a static bed of particles within a container and recovering water condensate.

Felled tree logs and branches are chipped and dried to use in biomass boilers. Freshly felled trees contain moisture in excess of 60%. This is normally dried down to below 30% moisture content which is ideal to run biomass boilers to its optimum efficiency. Many drying systems such as, kiln drying, rotary drying, fluidized bed drying etc. including natural sun drying dry the chipped wood, however, in such drying systems handling and storage of bulk chipped wood, its drying, protective storage of dried chipped wood is of concern when it is exposed to the influence of atmosphere. The preferred embodiment is an efficient and cost effective method of drying wood chips and has multiple advantages over other drying systems such as; it reduces the energy required to dry, increase the protection to dried chipped wood from outside atmosphere, reduces the handling from start to end of the complete process, reduces human exposure to dust and fines inherent in wood chips handling process during its process, storage, transportation, saves time and costs. The preferred embodiment can be applied to evaporate liquid and dry many other types of solid particles of materials.

### BACKGROUND

The normal processes, movement and handling involved after chipping the tree logs and feed the biomass boiler would require; a large area for storage of chipped wood before it is transported to drying platform or chamber, spreading the chipped wood evenly on a platform if sun dried and kiln dried or loading into drying chambers of other type of drying systems, removing from the platform or unloading from the chamber after drying, providing protective storage to the dried chipped wood, if transported to another destination and providing protective storage at the destination. To sum up, the entire process from start to end, obviously will involve several stages of handling requiring machine and human intervention.

The drying of wood chips other than natural sun drying need at least a fully covered chamber as in kilns or in any other type of drying systems. Generally the drying of wood chips for the purpose of feeding biomass boiler is a low cost operation and is normally conducted in non-insulated chambers. There is an increasing tendency to use waste heat generated from sources for example in anaerobic digester plants and other types of renewable energy plants to dry the wood chips. Also in certain biomass boilers, some heat generated in the biomass boiler itself is used to pre dry the wood chips before it is fed into such boiler.

The preferred embodiment is a shipping container or a container of any shape permanently built with a unique drying mechanism to evaporate liquid and dry a static bed or moving static bed of wood chips or any wet particle material. It can also be used to store and transport such dried material. The drying system provides an efficient method to evaporate liquid and dry a static bed or moving static bed of particles contained in such container uniformly and at a quicker drying rate. It saves energy compared to other conventional drying methods. It can be connected to external heat exchangers, blowers and flue gas pipes to receive warm or hot air or flue gas herein referred to as air.

Particularly in a mobile drying system, it would require only two movements and handling of bulk chipped wood i.e. firstly, loading freshly chipped wet wood directly from the wood chipping machine into shipping container and secondly removing dried chipped wood before feeding into the biomass boiler. It will additionally provide a protective storage to the dried wood chips during transportation and storage. It increases the health and safety by reducing human exposure to dust and fines. If containerized in a standard shipping container, it benefits from the convenience and economy of commonly available facilities for handling and transporting of a shipping container thus saving time and costs.

The top, rear, front & base of the container is insulated externally or internally. Insulated partition walls are built leaving a narrow passage between each inner side of the container wall and the partition wall. At the bottom of such passage, plurality of closable vents are provided. A narrow passage is allowed between the entire length of the partition wall and the ceiling i.e. below the insulated top surface of the container. The bottom of the partition wall is firmly secured to the base of the container. A structure comprising plurality of tubes containing plurality of holes (air passages) is fixed permanently inside the container. In the case of the container base built with a movable floor comprising perforated conveyor belt or plurality of movable floor planks, any gaps in such system that allow the air to pass through will substitute or add up to the purpose of plurality tubes containing plurality of holes. The space underneath such systems and the tubes are connected to the hot air inlet into the container via manifold if required. Single or multiple openings with doors is provided on the top of the container for easier loading of wood chips into the container.

The container doors are shut and the wet wood chips are loaded from the top opening to fill in the container and the plurality tubes are buried in the bed of wood chips. After the wood chips is fully loaded the door is shut. When hot air is forced via the manifold, the arrangement of plurality of tubes containing plurality of holes distributes the hot air with uniform temperature at various locations and levels within the bed of wood chips. The forced hot air with an upward draft movement carries the moisture released from the wood chips upwards. During this upward movement from the bottom to the top surface of the bed of wood chips, the moist air will regain the lost heat as it passes each higher level plurality tubes. The resulting effect is uniform and quicker removal of moisture from the wood chips throughout the height, length and breadth of the static bed of wood chips. Also the hot air released at the top most level of the bed of wood chips, maintains the temperature of air enough to carry the released moisture above the surface of the bed of wood chips and maintain the insulated ceiling warm. This reduces the possibility of the moisture in the air after contact with the ceiling to re condense and drop back to the bed of wood chips. Also the insulation to rear and front reduce condensation on the inner surface of such sides. The hot moist air will find its way out via the narrow passage between the ceiling and the partition wall and then is pushed downwards along the narrow passage between the partition wall and the sides of the container. The exterior of the sides of the container is exposed to cooler atmospheric air temperature as such sides are not insulated. This keeps the inner surface of such sides cooler than the temperature of the outgoing moist air. The continuous cooling of the moisture laden air results in downdraft in the narrow passage due to continuous direct contact with such cooler surface. This naturally condenses the moisture in the air on the inner surface of such sides. The condensed water will flow down due to gravity and flow out of the container via opened bottom vents and the air also escapes the container via opened bottom vents. The entire process skips the need to use air extractors and heat exchangers due to the force of thermodynamics i.e. the temperature difference between inside and outside the container saving energy and maintenance costs. Also it is environment friendly because of reduced moisture and toxic elements thrown into the atmosphere. The water removed from condensation can be treated and stored for other uses.

### DESCRIPTION OF DRAWING

FIG. 1: (01) is the shipping container. (02) is the single inlet opening for the air warmer than the atmospheric air temperature (not shown in the drawing is the optional multiple inlet openings). (03), (04) and (05) serves as openings for loading chipped wood into (01).

FIG. 2: (06) is the frame made from plurality of tubes (07) containing plurality of holes (08) connected to a manifold (09). (09) is connected to (10) which serves as a provision to connect a blower, pump or a fan that force air into (01). (06) is designed to provide structural support to (07) which is fixed to (01). (06) will be buried under the bed of wood chips when (01) is fully loaded with wood chips. (06) in its entirety is also designed to distribute the forced hot air uniformly throughout such bed of wood chips contained in (1). The blower or pump or fan connected to the provision for outlet; force the inlet air upwards causing an upward draft of the hot air.

FIG. 3: This is a part of the cross section view of preferred embodiment showing (11) and (12) insulation to top and bottom of the container to reduce condensation on such inner surface. Not shown is the insulation to the rear and front of the container. (13) is the partition wall allowing a narrow passage (14) between the cooler inner surface of both sides (15) of the container and (13) as well as narrow passage (16) between (13) and the ceiling. (17) is the plurality tubes containing plurality holes at different levels. (17) is buried in the bed of wood chips (18) after (18) is loaded into (1). (19) is the upward draft movement of moist air. (20) is the moist air attracted towards the colder inner surface of (15) and pushed into the narrow passage (16). (21) is the moist air with downdraft movement due to continuous cooling from (15). (22) is the closable vent. (23) dried air escapes the vent (22) and the condensed water also flow out via (22).

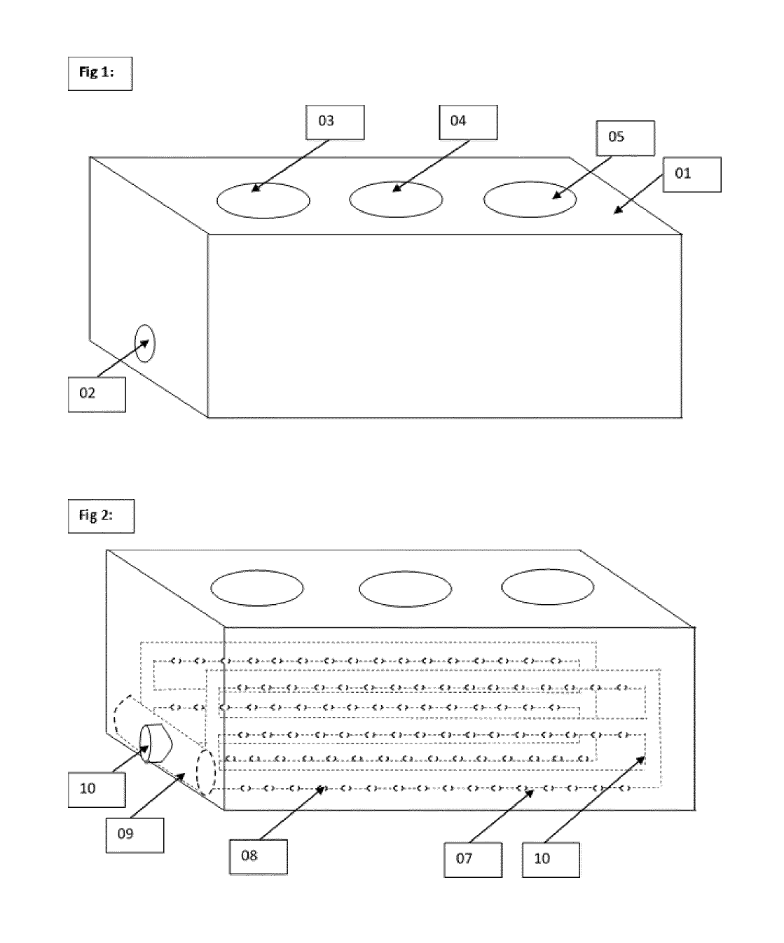

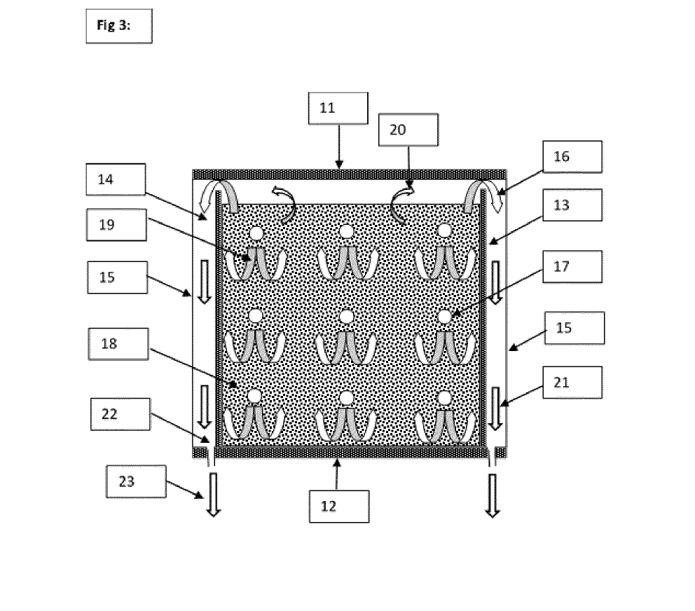

1. A method and apparatus for evaporating liquid and drying particles more particularly within a flat roof [11] rectangular shaped shipping container [01] and recovering water condensate [23], the method comprising forcing flue gas or air at a temperature greater than ambient air at at least one inlet [02] and to condense moisture laden gas more particularly on side wall surfaces [15] en-route to condensate and moist flue gas or air outlet [22], such container comprising a top surface with a more particular horizontally flat surface [11], a bottom surface [12], a front surface, a back surface, all of which are more particularly insulated, and un-insulated side wall surfaces [15], and together the surfaces define a space within which a flue gas or air inlet manifold [09] connects to the at least one flue gas or air inlet [02] and connects to plurality of flue gas or air outlets [08], such flue gas or air outlets [08] which in use are adjacent the particles [18], the container [01] further including insulated partition side walls [13] which together with insulated front, back, top and bottom surfaces define a drying space and in use contain the particles [18] and provide in conjunction with the top [11] and side wall surfaces [15] passage ways [16] for the moist laden flue gas or air [20] to exit such drying space and a condensing surface on the un-insulated side wall surfaces [15] for the moist laden flue gas or air [20] to condense, such container [01] has at least one closable opening [03,04,05] for loading the particles [18] into such container [01], such container's [01] condensate and moist flue gas or air outlet [22] is plurality of closable vents, and the inlet [02] or inlets can connect with detachable mechanical blower to force flue gas or air into such container[01].
